(19) United States
(12) Patent Application Publication
(10) Pub. No.: US 2009/0012794 A1
(43) Pub. Date: Jan. 8, 2009

(54) System For Giving Intelligibility Feedback To A Speaker

(75) Inventors: Sander Jeroen van Wijngaarden, Den Haag (NL); Jan Adrianus Verhave, Bilthoven (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Nerderlandse Organisatie voor toegepast- natuurwetenschappelijk Onderzoek TNO, Delft (NL)

(21) Appl. No.: 12/278,839

(22) PCT Filed: Feb. 8, 2007
(86) PCT No.: PCT/NL07/50050

§ 371 Date: Aug. 8, 2008

(30) Foreign Application Priority Data
Feb. 8, 2006 (EP) 06075278.9

(51) Int. Cl. G10L 11/00

(52) U.S. Cl. 704/270; 704/E11.001

(57) ABSTRACT

System for giving intelligibility feedback to a speaker (1), speaking for an audience (2), comprising a first microphone (3) at the speaker's side and a second microphone (4) at the audience's side. Both microphones are connected to processing means (5) which are arranged to compute an intelligibility value based on both microphones' signals. Signalling means (6), preferably at the side of the audience, are arranged to generate an intelligibility feedback signal depending on the calculated intelligibility value. The signalling means being arranged to generate said intelligibility feedback signal in an optical form, visible for the speaker concerned. Wireless connection means (19) may interconnect the microphones, the processing means and the signalling means.

### FIELD

The invention concerns a system for the improvement of the intelligibility of speakers addressing a target audience.

### BACKGROUND

Speaking intelligibly in public is an art. Although every public speaking course devotes some attention to this aspect (“please think about the back row”), various reasons can be given for why a speaker may be poorly intelligible. In part this will have to do with the speaker himself (speech style, speaking speed, volume), but on the other hand it may have to do with the room (e.g. ventilation or traffic noise etc.) and the quality of the speaking facility. Everyone knows examples of lectures or speeches where the speaker was totally unintelligible to half of his audience.

### SUMMARY

One aim of the invention is to provide a system for giving intelligibility feedback to a speaker, speaking for a—real or imaginary (e.g. in a test or preparation situation)—audience, comprising an (at least) first microphone at the speaker's location and an (at least) second microphone at the audience's location, said first and second microphone being connected to processing means which are arranged to compute in real-time or nearly real-time, a speech transmission index value based on the (at least) first microphone's signal and the (at least) second microphone's signal and to convey an intelligibility feedback signal to the speaker when the speech transmission index value lies within a certain range or an intelligibility feedback signal when said speech transmission index value lies outside a certain range.

Said intelligibility feedback signal may be in the form of e.g. a green light, visible for the speaker concerned, when the intelligibility value lies within a range which corresponds to a good intelligibility, or e.g. a (for instance blinking) red light when the intelligibility value lies outside that range, corresponding to a insufficient intelligibility. When the speaker sees that the light is green (s)he knows that (s)he is clearly understood. If the light turns red, then (s)he has to talk more clearly, louder, slower or better into the microphone. Such a “speech intelligibility light” (although the intelligibility feedback signal may be output in a different form then a green/red light), for example, can be placed in the rear of the auditorium or even in various places spread throughout the hall.

The algorithm which may be used by the processing means—arranged to compute a (near) real-time intelligibility value based on the signals of the first and second microphones—may be based on the so-called Speech Transmission Index (STI), varying from 0 (completely unintelligible) to 1 (perfect intelligibility), which gives a speech transmission quality value. In STI testing, speech may be modelled by a test signal with speech-like characteristics. According to the STI concept speech can be described as a fundamental waveform that is modulated by low-frequency signals. STI employs a complex amplitude modulation scheme to generate its test signal. At the receiving end of the transmission path, the depth of modulation of the received signal is compared with that of the test signal in a number of frequency bands. Reductions in the modulation depth are associated with loss of intelligibility. Derived from the STI method are the Rapid Speech Transmission Index (RASTI) and the Speech Intelligibility Index (SII).

Chi Taishih er al: “Spectro-temporal modulation transfer functions and speech intelligibility” Journal of the acoustical society of America, AIP Acoustical society of America, melvill, Ny, US, vol 1-6, no 5 Nov. 1999 (1999-1) pages 2719-2732 is concerned with a MTF analyses and discusses speech transfer properties using a spectro-temporal modulation index in two situations (1) determining the quality of a transmission medium and (2) assessing the intelligibility of a given noisy speech sample. However, the resulting speech intelligibility signal value ρ is used to test the transmission properties of the medium or the quality of a noisy speech signal and is not based on a real time generated intelligibility signal, to speak more clearly, in terms of a predetermined acceptable range intelligibility values which are conveyed to him in the form of a speech intelligibility signal.

In addition, US2005/135637 is concerned with speech intelligibility measurements, using a system having primary and secondary microphones. However, the setup is used to evaluate intelligibility of audio output from the loudspeakers; not for realtime conveying this output as a cross intelligibility value signal to a speaker.

In addition, the publication, (Sanchez Bote et al: “a real-time auditory-based microphone array assessed with e-rasti evaluation proposal”, 2003 IEEE International conference on acoustics, speech, and signal processing. Proceedings, (ICASSP) Honkon, April 6-10, Vol 1 of 6, Apr. 6, 2003, pages V477-V480) discusses a real-time auditory based microphone array. This nested microphone array enhances the acoustic properties of speech transmission, through reverberation analysis and adjustment. A Modified Wiener Method is described showing some similarities in the phase weighted MTF approach of the present invention. It does not disclose or suggest to use a phase-weighted modified transfer function as an intelligibility indicator for conveying an intelligibility feedback signal to a speaker.

Since the use of artificial test signals is impossible when providing intelligibility feedback to a speaker in a live situation, only so-called speech-based STI measurements, which use real speech as a probe signal, will be applicable. From experiments it was learned that an improved STI method, called “Phase Weighting” (PW) STI, to be discussed below, is sufficiently resistant to e.g. disturbance by other speakers (e.g. within the audience)—an important factor for intelligibility—to be used within the intelligibility's processing means for discriminating between an acceptable and not acceptable intelligibility of the speaker at the audience's side.

A so-called Modulation Transfer Function (MTF) is an important interim result in the determination of the (PW) STI. The MTF is normally estimated with the aid of modulated noise signals, e.g. simulated human speech. In the present case, however, for understandable reasons, the measurement has to performed in (nearly) real-time with natural speech, viz. the speaker's speech. The most common form of the MTF for STI-with-speech (sMTF) measurements is:

$$M T {F}_{payton} ∼ \frac{‖ crossspectrum ‖}{‖ autospectrum ‖} \qquad ( 1 )$$

In this case use is made of the cross spectrum (“crossspectrum”) between speech signals at the input side (the speaker's location) and the output side (the audience's side) of the “communication channel” (viz. through the room), standardized with (the modulus of) the spectrum of the input signal (“autospectrum”). If speech is present at both ends of the transmission path (room, hall)—viz. the “official” speaker's speech and interfering speech e.g. within the audience or in the audience's environment—, the risk exists of scoring the MTF too high (too favourably). This drawback could be prevented by paying attention to the phase of the cross spectrum and counting only those parts of the signal between input and output that are sufficiently in phase. This is reproduced in the following comparison:

$$M T {F}_{phaseweighting} ∼ \frac{‖ crossspectrum ‖ \cdot f ( ∠ ( crossspectrum ) )}{‖ autospectrum ‖} \qquad ( 2 )$$

in which ƒ(‰(crossspectrum)) denotes a function of the phase of the cross spectrum. Use could be made of weighting functions in the form of the following system

$$w ( ϕ ) \text{:} \{ \begin{matrix}ϕ ∈ ( - π , π ] \\ \vert ϕ \vert \leq \frac{π}{2 α} \text{:} w ( ϕ ) = {cos}^{2} ( αϕ ) \\ \vert ϕ \vert > \frac{π}{2 α} \text{:} w ( ϕ ) = 0\end{matrix} \qquad ( 3 )$$

in which the value of alpha could be set at about 0.5.

The method outlined here is stricter than previous methods in the “punishment” of phase shifts and thus is considerably more resistant to interfering speech (“babble”). Since interfering speech is one of the most important sources of reduced intelligibility, this method is very useful for application in the processing means of the present intelligibility feedback system (“intelligibility light”) as outlined above.

In general the MTF will be calculated for modulation frequencies of 0.63 to 12.5 Hz and in the octave bands of 125 Hz to 9 kHz. For the “intelligibility light”, however, it may be preferred to make both frequency ranges narrower (1 to 3 Hz and 500 Hz to 2 kHz respectively). Due to this preferred restriction the intelligibility calculation time—performed by the processing means—could be reduced more than a factor 2, while the processing means could operate using a lower sampling frequency. Besides, estimation of the MTF at modulation frequencies above 3 Hz is inaccurate unless long speech fragments are used; in that case, however, the speaker would have to wait too long before the status of the light would updated, so that the light would “lag behind.” Finally, higher modulation frequencies are of subordinate importance for the accuracy of the STI estimation.

Besides simple and quick STI measurement, the reliability of the measured MTF is important too. For instance, when pulse-like signals are registered (such as doors slamming shut or applause), the MTF may be greatly distorted. The processing means will thus have to determine whether the measured signals are speech indeed; if not, the measurement must be discarded as unreliable. This could be implemented by fitting the measured envelope spectra to an anticipated form, e.g. a parabola or another simple mathematical function. The fitting error between both could be used as a quality measure; if the fitting error is too high the intelligibility light could become red and/or the green light will go out.

Finally, consideration should be given to the effect of the speech signal level. If the speech signal level is too low, listening may become uncomfortable, even if the STI indicates an (in principle) intelligible signal. For that reason, preferably, the processing means determine too low signal levels and process that situation into a non-intelligible signal (“red light”).

### EXEMPLARY EMBODIMENT

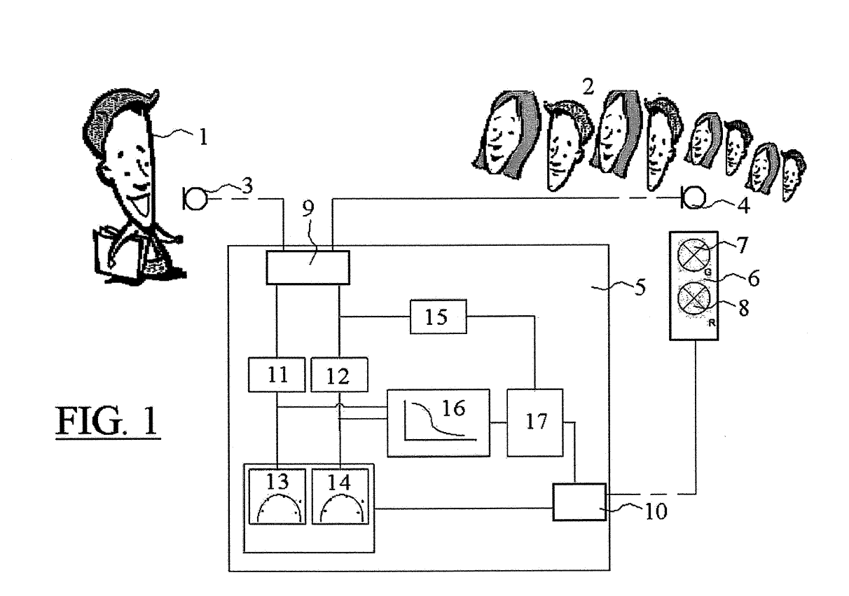

FIG. 1 shows a first embodiment of the invention;

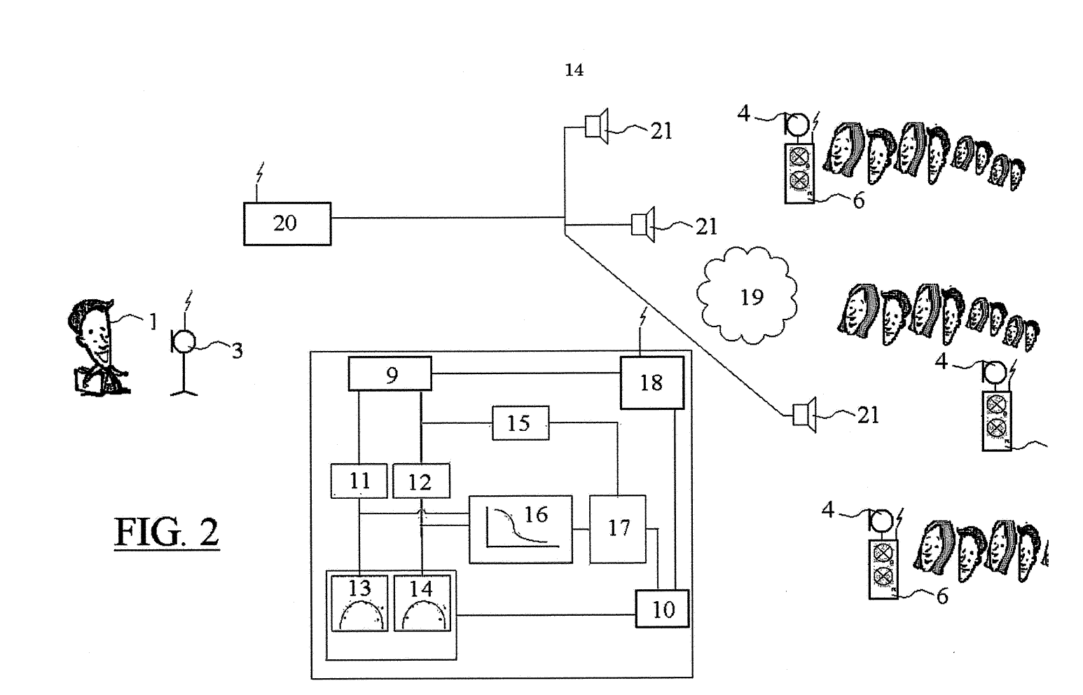

FIG. 2 shows a second embodiment of the invention.

The system for giving intelligibility feedback to a speaker 1, speaking for an audience 2, comprises a first microphone 3 at the speaker's side and a second microphone 4 at the audience's side. The first and second microphone are connected to a processing module which is arranged to compute a real-time or nearly real-time intelligibility value based on the signals originated by the first microphone and the second microphone. A signalling module 6 is connected (directly or remotely as will be discussed below) to the processing module 5 and is arranged to generate a (positive) intelligibility feedback signal—e.g. a green light 7—when the intelligibility value lies within a certain (acceptable) range, or to generate a (negative) intelligibility feedback signal—e.g. a red light 8—when the intelligibility value lies outside a certain range. The signalling module in this exemplary embodiment is thus arranged to generate the intelligibility feedback signal in an optical form, which is visible for the speaker 1. When the green light 7 is green the speaker may assume that his intelligibility, as perceived by the audience, is good.

The processing module 5 comprises an microphone interface 9. The signal of the first microphone 3 is fed to a module 11 in which the envelope spectrum the first microphone's signal is calculated. The signal of the second microphone 4 is fed to a module 12 in which the envelope spectrum the second microphone's signal is calculated. Both calculated envelopes are supplied to a module 16 in which the phase-weighted sMTF is calculated as discussed in the previous paragraph, which calculated phase-weighted sMTF value is fed to a module 17. A module 15, between the second microphone 4 and module 17 calculates a listening level value and feeds it to module 17. Module 17 computes an approximate STI value from phase-weighted sMTF value (module 16) and the listening level value (module 15) varying from 0 (completely unintelligible) to 1 (perfect intelligibility) and feeds is to a control module 10, to which the signalling module 6 is connected and which controls the status of signalling module 6 (“red”/“green”). The envelope spectra which are calculated in modules 11 and 12 are also fed to modules 13 and 14 respectively, in order to determine whether the measured signals are speech signals indeed and to discard the measurement if not. In modules 13 and 14 the measured envelope spectra are fit (matched) to an anticipated form, e.g. a parabola or another simple mathematical function. The fitting error between both is used as a second value for control module 10 to set the signalling module's status: if the fitting error is too high the red light 8 should go on and the green light 7 out.

It might be preferred that the signalling module is located at the side of the audience, especially in the neighborhood of the second microphone 4 which, together with the first microphone 3, is responsible for the intelligibility rate which is computed by the processing module 5. The signalling module 6, the processing module 5 and the second microphone 4 could be integrated within one common housing. It is noted here that use might be made by several second microphones, located at several locations in a hall, each of which is connected to a common or individual processing module, responsible for the computation of an intelligibility value (rate), valid for that specific second microphone's environment. As FIG. 2 shows, those second microphones 4 could, as well as the first microphones 3 and the (common) processing module 5, be interconnected by means of a wireless network 9 (all relevant system components should comprise wireless I/O interfaces, as indicated by antennas 10. The processing module 5 could, together with the relevant second microphone 4 and signalling module 6, be integrated in one common housing. In that case each second microphone 4 has its own processing and signalling means. However, it could be preferred to have a common processing module, connected with several second microphones 4. In that configuration the processing means could be used in a time-shared way, processing the signals from the second microphones (and the first microphone 3) in a cyclic way, one after the other. Using such a common processing module could result in cost reduction.

In some situations it may be preferred that the signalling module is located at the side of the speaker, e.g. in cases where the speaker can not or hardly see his audience, which may be the case at public address systems. In that case the signalling module may comprise the display means (e.g. the lights 7 and 8 or other display means, e.g. an LCD or LED based screen) of several locations, which are controlled—via the processing means (local or common, as discussed above)—by the relevant second microphones.

As discussed above, the system component may be interconnected by means of a wireless network 9. In that case—illustrated in FIG. 2, the relevant system components—the processing module, the first microphone(s), the second microphone(s) and the signalling module(s)—should comprise wireless I/O interfaces, as indicated by the antennas 10.

The processing module 5 is arranged to estimate or calculate a Modulation Transfer Function (MTF) based on the speaker's speech—picked up by the first microphone 3 and transferred to the processing module 5 via a cable or via a wireless path 9, using the cross spectrum between the signal received by the first microphone 3 and the signal received by the relevant second microphone 4. In the processing module 5 the cross spectrum is standardized with the auto spectrum of the first microphone's signal or a modulus of it. Subsequently, the processing module 5 detects the phase of the cross spectrum and counts only those parts of the signal of which the phase difference does not cross a certain value. The MTF may e.g. be calculated for modulation frequencies between 1 and 3 Hz and in the octave bands between 0.5 and 2 kHz. As discussed in the previous paragraph, the processing module may be arranged to fit the measured enveloping spectra to an anticipated form—e.g. a parabola or another simple mathematical function—and to control the generation of the intelligibility feedback signal in dependency of the fitting error. Moreover, as discussed before, the processing module 5 may be arranged to control the generation of the intelligibility feedback signal in dependency of the signal level output by the first or second microphone, to include the effect of (too low) speech level, which is uncomfortable for the listening audience and thus should be signalled by the relevant signalling module.

Finally, in most practical situations the speaker 1 will address his speech via a public address system, which in FIG. 2 is indicated by a speech amplifier 20 to which the wireless microphone 3 is connected, and a number of loudspeakers 21 at the side of the audience.

1. A system for giving intelligibility feedback to a speaker, speaking for an audience, comprising:
a first microphone at the speaker's side
a second microphone at the audience's side, said first microphone and said second microphone being connected to a processing module arranged to compute a real-time or nearly real-time speech transmission index value based on a signal from said first microphone and a signal from said second microphone; and
a signaling module connected to said processing module and arranged to convey an intelligibility feedback signal to the speaker when said speech transmission index value lies within a certain range or to generate an intelligibility feedback signal when said speech transmission index value lies outside a certain range.

2. The system according to claim 1, said signaling module being arranged to generate said intelligibility feedback signal in an optical form, visible for the speaker.

3. The system according to claim 1, said signaling signaling module being located at the side of the audience.

4. The system according to claim 1, said signalling signaling module being located at the side of the speaker.

5. The system according to claim 3, comprising a wireless connection network, arranged to interconnect, at least in part, the processing module, the first microphone, the second microphone and the signaling module.

6. The system according to claim 1, the processing module being arranged to estimate or calculate a speech transmission index value from a Modulation Transfer Function (MTF) using a cross spectrum between the signal received by the first microphone and the signal received by the second microphone, said cross spectrum being standardized with the auto spectrum of the signal from the first microphone or a modulus of the signal from the first microphone.

7. The system according to claim 6, wherein the Modulation Transfer Function is phase-weighted by detecting a phase difference of said cross spectrum and counting only those parts of the signals from the first and second microphones which are in phase within a predetermined phase difference value.

8. The system according to claim 7, wherein the transfer function MTF is expressed as
$$M T {F}_{phaseweighting} ∼ \frac{‖ crossspectrum ‖ \cdot f ( ∠ ( crossspectrum ) )}{‖ autospectrum ‖}$$
in which ƒ(‰(crossspectrum)) denotes a phase weight function that is zero outside a predetermined phase difference interval.

9. The system according to claim 7, wherein the phase weight function w is expressed as:
$$w ( ϕ ) \text{:} \{ \begin{matrix}ϕ ∈ ( - π , π ] \\ \vert ϕ \vert \leq \frac{π}{2 α} \text{:} w ( ϕ ) = {cos}^{2} ( αϕ ) \\ \vert ϕ \vert > \frac{π}{2 α} \text{:} w ( ϕ ) = 0\end{matrix}$$

10. The system according to claim 1, wherein said intelligibility feedback signal is further calculated as a function of a primary intelligibility value based on an intelligibility analysis of the first microphone signal; and said calculated speech transmission index value.

11. The system according to claim 6, the MTF being calculated for modulation frequencies of 1 to 3 Hz and in the octave bands of 500 Hz to 2 kHz.

12. The system according to claim 6, the processing module being arranged to fit the measured enveloping spectra to an anticipated form and to control the generation of said intelligibility feedback signal in dependency of the fitting error.

13. The system according to claim 1, the processing module being arranged to control generation of said intelligibility feedback signal in dependency of a signal level output by the first microphone or the second microphone.

14. The system according to claim 4, comprising wireless connection means, arranged to interconnect, at least in part, the processing means, the first microphone, the second microphone and the signaling module.
